(19) United States
(12) Patent Application Publication
(10) Pub. No.: US 2022/0335829 A1
(43) Pub. Date: Oct. 20, 2022

(54) SYSTEM AND METHOD FOR VEHICLE EVENT DATA PROCESSING FOR IDENTIFYING AND UPDATING PARKING AREAS

(71) Applicant: Wejo Limited, Manchester (GB)

(72) Inventors: Stephen Millington, St. Helens (GB); Dylan Sumner, Manchester (GB)

(21) Appl. No.: 17/722,340

(22) Filed: Apr. 16, 2022

Related U.S. Application Data
(60) Provisional application No. 63/176,179, filed on Apr. 16, 2021.

(51) Int. Cl. G08G 1/14

(52) U.S. Cl. CPC G08G 1/148; G08G 1/142

(57) ABSTRACT

A system and method of vehicle event data processing for identifying and updating parking areas. The method includes periodically identifying first car parking area candidates from a set of ingested vehicle event data; merging car parking area candidates that meet spatial merging criteria to determine second car parking area candidates; spatially comparing the second car parking area candidates to existing car park areas to allocate the second car parking area candidates into update car parking area candidates and new car parking areas; merging the update car parking area candidates that meet spatial merging criteria to allocate the update car parking area candidates into updated car and out of service car parking areas; assigning spatial and temporal identifiers to the new car parking areas; and updating a parking area data set responsive to the new car, the updated car and the out of service car parking areas.

### TECHNICAL FIELD

This disclosure relates to methods and systems for identifying and updating parking areas for vehicles, such as automobiles.

### BACKGROUND

Nowadays, there is a large amount of data streamed from automobiles and other vehicles, and this data is used for various purposes, such as for providing traffic conditions of roads. In many scenarios, vehicles are configured to transmit or stream the same data continuously or periodically to a remote location, such as a remote server. This data may be used to identify or specify a journey for a vehicle, which may have a start and end location.

### SUMMARY

According to one aspect of the disclosure, there is provided a system comprising: a memory including program instructions and a processor. The processor is configured to execute instructions to at least: ingest vehicle event data; process the vehicle event data at a server to identify a plurality of parking areas; add the parking area data set to a data product; and provide the data product to a customer. The processing comprises: periodically identifying first car parking area candidates from a set of the ingested vehicle event data; merging car parking area candidates that meet spatial merging criteria to determine second car parking area candidates; spatially comparing the second car parking area candidates to existing car park areas to allocate the second car parking area candidates into update car parking area candidates and new car parking areas; merging the update car parking area candidates that meet spatial merging criteria to allocate the update car parking area candidates into updated car parking areas and out of service car parking areas; assigning spatial and temporal identifiers to the new car parking areas; and updating a parking area data set responsive to the new car parking areas, the updated car parking areas and the out of service car parking areas.

According to various embodiments, the system may further include any one of the following features or any technically-feasible combination of some or all of the following features:
the processing for identifying first car parking area candidates includes clustering a plurality of journey points indicated by the ingested vehicle event data to obtain a cluster of points and defining a shape around the cluster of points;
the processing for identifying first car parking area candidates further includes: identifying a plurality of journeys from the ingested vehicle event data; matching the ingested vehicle event data to map data from a map database; selecting the plurality of journey points from the plurality of journeys; and clustering the selected journey points with a clustering algorithm to obtain the cluster of points;
the plurality of journey points from the plurality of journeys are selected based on whether corresponding vehicle event data indicates a journey start or journey end;
the shaped defined around the cluster of points is a geoshape that is represented by a geohash;
the processing for merging car parking area candidates of the first car parking area candidates includes determining whether there is a spatial overlap between a first car parking area candidate and a second car parking area candidate and merging the first car parking area candidate and the second car parking area candidate in response to determining that there is a spatial overlap between the first car parking area candidate and the second car parking area candidate;
the processing for spatially comparing the second car parking area candidates to existing car park areas includes determining whether a second parking area candidate spatially overlaps with an existing car park area and, wherein the processing further includes determining the second parking area candidate as an update parking area candidate when it is determined that the second parking area candidate spatially overlaps with an existing car park area and determining the second parking area candidate as a new parking area when it is determined that the second parking area candidate does not spatially overlap with an existing car park area;
the processing for spatially comparing the second car parking area candidates to existing car park areas includes, for a second car parking area candidate, comparing a geohash indicating a geographical boundary of the second car parking area candidate to a geohash indicating a geographical boundary of an existing car park area;
the spatial and temporal identifiers to the new car parking areas includes a geohash and a timestamp; and/or
a first one of the out of service car parking areas is determined as a first update car parking area candidate in response to determining that the first update car parking area candidate is to be merged with a second update car parking area candidate.

According to another aspect of the disclosure, there is provided a method of updating a parking area data set and using the updated parking area data set for providing a data product. The method includes: ingesting vehicle event data; periodically identifying first car parking area candidates from a set of the ingested vehicle event data; merging car parking area candidates of the first car parking area candidates that meet spatial merging criteria to determine second car parking area candidates; spatially comparing the second car parking area candidates to existing car park areas to allocate the second car parking area candidates into update car parking area candidates and new car parking areas; merging the update car parking area candidates that meet spatial merging criteria to allocate the update car parking area candidates into updated car parking areas and out of service car parking areas; assigning spatial and temporal identifiers to the new car parking areas; and updating a parking area data set responsive to the new car parking areas, the updated car parking areas, and the out of service car parking areas; and providing the data product to a customer, wherein the data product includes data generated based on the parking area data set.

According to various embodiments, the method may further include any one of the following features or any technically-feasible combination of some or all of the following features:
the identifying first car parking area candidates step includes clustering a plurality of journey points indicated by the ingested vehicle event data to obtain a cluster of points and defining a shape around the cluster of points;
the identifying first car parking area candidates step further includes: identifying a plurality of journeys from the ingested vehicle event data; matching the ingested vehicle event data to map data from a map database; selecting the plurality of journey points from the plurality of journeys; and clustering the selected journey points with a clustering algorithm to obtain the cluster of points;
the plurality of journey points from the plurality of journeys are selected based on whether corresponding vehicle event data indicates a journey start or journey end;
the shaped defined around the cluster of points is a geoshape that is represented by a geohash;
the merging car parking area candidates of the first car parking area candidates step includes determining whether there is a spatial overlap between a first car parking area candidate and a second car parking area candidate and merging the first car parking area candidate and the second car parking area candidate in response to determining that there is a spatial overlap between the first car parking area candidate and the second car parking area candidate;
the spatially comparing the second car parking area candidates to existing car park areas step includes determining whether a second parking area candidate spatially overlaps with an existing car park area and, wherein the method further includes determining the second parking area candidate as an update parking area candidate when it is determined that the second parking area candidate spatially overlaps with an existing car park area and determining the second parking area candidate as a new parking area when it is determined that the second parking area candidate does not spatially overlap with an existing car park area;
the spatially comparing the second car parking area candidates to existing car park areas step includes, for a second car parking area candidate, comparing a geohash indicating a geographical boundary of the second car parking area candidate to a geohash indicating a geographical boundary of an existing car park area;
the spatial and temporal identifiers to the new car parking areas includes a geohash and a timestamp; and/or
a first one of the out of service car parking areas is determined as a first update car parking area candidate in response to determining that the first update car parking area candidate is to be merged with a second update car parking area candidate.

### BRIEF DESCRIPTION OF THE DRAWINGS

Preferred exemplary embodiments will hereinafter be described in conjunction with the appended drawings, wherein like designations denote like elements, and wherein:

FIG. 1 is a system diagram of an environment in which at least one of the various embodiments can be implemented;

FIG. 2 illustrates example operations for determining parking areas from a data set of journeys formed from connected vehicle data; and

FIG. 3 illustrates example operations for updating, reconciling, and maintaining parking area data sets.

### DETAILED DESCRIPTION

The subject matter of this application relates to the subject matter of U.S. Patent Application Publication No. 2022/0082405 A1 (U.S. Ser. No. 17/215,902), the entire contents of which are incorporated herein by reference.

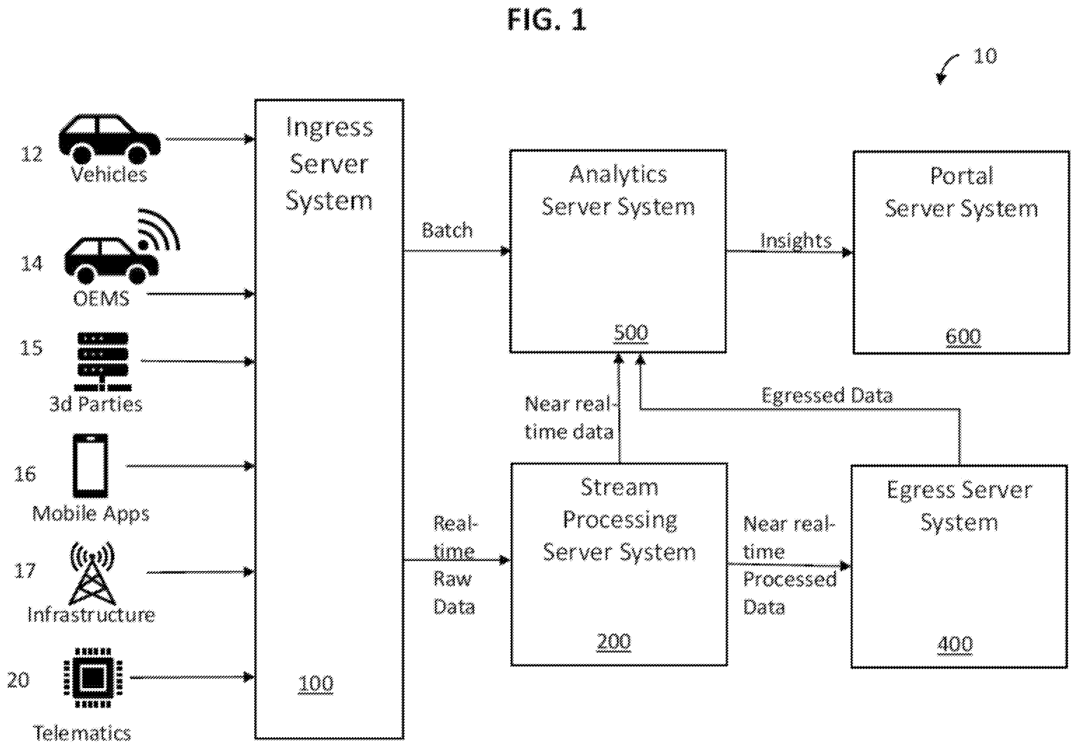

FIG. 1 is a logical architecture of system 10 for geolocation event processing and analytics in accordance with at least one embodiment. In at least one embodiment, Ingress Server system 100 can be arranged to be in communication with Stream Processing Server system 200 and Analytics Server system 500. The Stream Processing Server system 200 can be arranged to be in communication with Egress Server system 400 and Analytics Server system 500.

The Egress Server system 400 can be configured to be in communication with and provide data output to data customers and consumers. The Egress Server system 400 can also be configured to be in communication with the Stream Processing Server system 200.

The Analytics Server system 500 is configured to be in communication with and accept data from the Ingress Server system 100, the Stream Processing Server system 200, and the Egress Server system 400. The Analytics Server system 500 is configured to be in communication with and output data to a Portal Server system 600.

In at least one embodiment, Ingress Server system 100, Stream Processing Server system 200, Egress Server system 400, Analytics Server system 500, and Portal Server system 600 can each be one or more computers or servers. The various components shown in the figure can be configured to operate in many manners, of which the following are examples: one or more of Ingress Server system 100, Stream Processing Server system 200, Egress Server system 400, Analytics Server system 500, and Portal Server system 600 can be configured to operate on a single computer, for example a network server computer, or across multiple computers; the system 10 can be configured to run on a web services platform host such as Amazon Web Services (AWS) or Microsoft Azure; the Ingress Server system 100, Stream Processing Server system 200, Egress Server system 400, Analytics Server system 500, and Portal Server system 600 can be hosted on Hosting Servers; and the Ingress Server system 100, Stream Processing Server system 200, Egress Server system 400, Analytics Server system 500, and Portal Server system 600 can be arranged to communicate directly or indirectly over a network to the client computers using one or more direct network paths including Wide Access Networks (WAN) or Local Access Networks (LAN).

The Ingress Server system 100 receives vehicle event data streams, for example as trip data identified from OEMs 14, vehicles 12, third parties 15, mobile apps 16, connected infrastructure 17, telematics service providers 20, and the like. Data from OEMs 14 may come in the form of periodic or streaming connected vehicle data uploaded from OEM vehicles to an OEM data lake in real time or near-real time (“connected vehicle data streams”). In that case, the Ingress Server system 100 connects to the OEM data lake to receive all or a portion of the data from the connected vehicle data streams.

In at least one embodiment, Analytics Server system 500 can be one or more computers arranged to analyze event data. Both real-time and batch data can be passed to the Analytics Server system 500 for processing from other components as described herein. Data provided to the Analytics Server system 500 can include, for example, data from the Ingress Server system 100, the Stream Processing Server system 200, and the Egress Server system 400.

In an embodiment, the Analytics Server system 500 can be configured to accept vehicle event payload and processed information, which can be stored in data stores. The storage may include real-time egressed data from the Egress Server system 400, transformed location data and reject data from the Stream Processing Server system 200, and batch and real-time, raw data from the Ingress Server system 100. Ingressed locations stored in the data store can be output or pulled into the Analytics Server system 500. The Analytics Server system 500 can be configured to process the ingressed location data in the same way as the Stream Processor Server system 200. The Stream Processing Server system 200 can be configured to split the data into a full data set including full data (transformed location data filtered for latency and the rejected latency data) and a data set of transformed location data. The full data set is stored in the data store for access or delivery to the Analytics Server system 500, while the filtered transformed location data is delivered to the Egress Server system 400. Real time filtered data can be processed for reporting in near real time, including reports for performance 522, Ingress vs. Egress 524, operational monitoring 526, and alerts 528.

The Analytics Server system 500 performs a Journey Segmentation analysis of the event data and builds individual Journeys from Journey segments. A Journey is an individualized vehicle road trip described with geocoded and temporal data. In some examples, Journeys may have starting and/or ending points blurred or omitted for data products provided to customers. As an example, Journey building may occur as described in U.S. Patent Application Publication No. 2020/0256683 A1, which is incorporated herein by reference.

In an embodiment, the system 10 can be configured to process vehicle event data to provide enhanced insights and efficient processing. Exemplary processes and systems for processing event data comprise snapping of data points to roads, finding areas of parking related to points of interest, classifying journeys, address matching, traffic volume time series forecasting, determining road co-dependency, identifying traffic congestion, and anomaly detection.

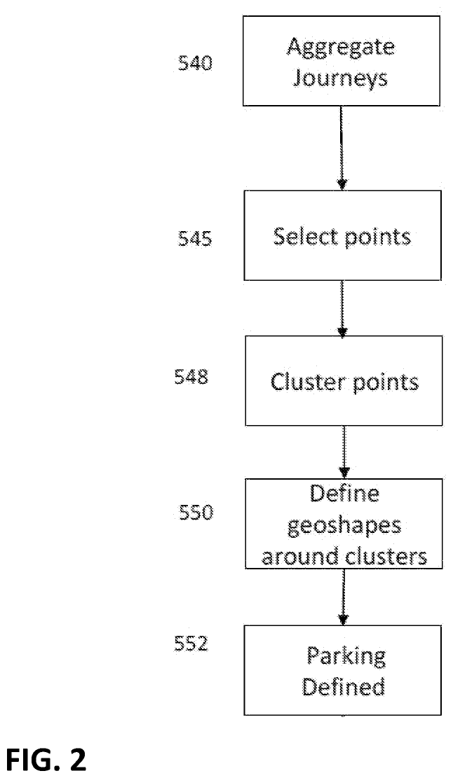

In an embodiment, the system can be configured to identify parking areas. As shown in FIG. 2, at block 540 journeys are aggregated. In an embodiment, journeys can be identified as described hereinabove. Journeys can also be identified in vehicle event data streams ingressed by the Ingress Server system 100, for example as trip data identified from OEMs 14 (FIG. 1), vehicles 12, third parties 15, mobile apps 16, connected infrastructure 17, telematics service providers 20, and the like (see FIG. 1). In embodiments, at block 545, journey points are selected for defining parking. For example, in an embodiment, the Egress Server system 400 can be configured to provide a “Parking” filter configured to restrict the data to the start and end of journey (Ignition—key on/off events) within the longitude/latitudes associated with the map area to analyze for parking areas. At block 548, the system 10 is configured to cluster these points into point clusters. In an embodiment, it was found that a density-based clustering algorithm, such as DBSCAN, provided improved results for identifying parking areas via clustering journey vehicle event data points.

At block 550, the system 10 is configured to define a geoshape around the cluster of points. The boundaries of the point clusters are geoshaped to geographical areas by specifying the outer edges of the clusters with geometric specifiers, such as geohash descriptors or latitude/longitude pairs. With the geoshapes defined, the geographical areas bounding the clusters can be readily map-matched. At block 552, the system 10 operations map-match the geoshapes and define the parking area(s).

The above process and steps describe the determination of parking areas from high volume streaming connected vehicle data. As the volume of vehicles on the road continues and grows, and connected vehicle data from those vehicles continues to provide more data with time, there becomes an opportunity for the system 10 to periodically recalculate parking area determinations and the need to maintain the parking area database.

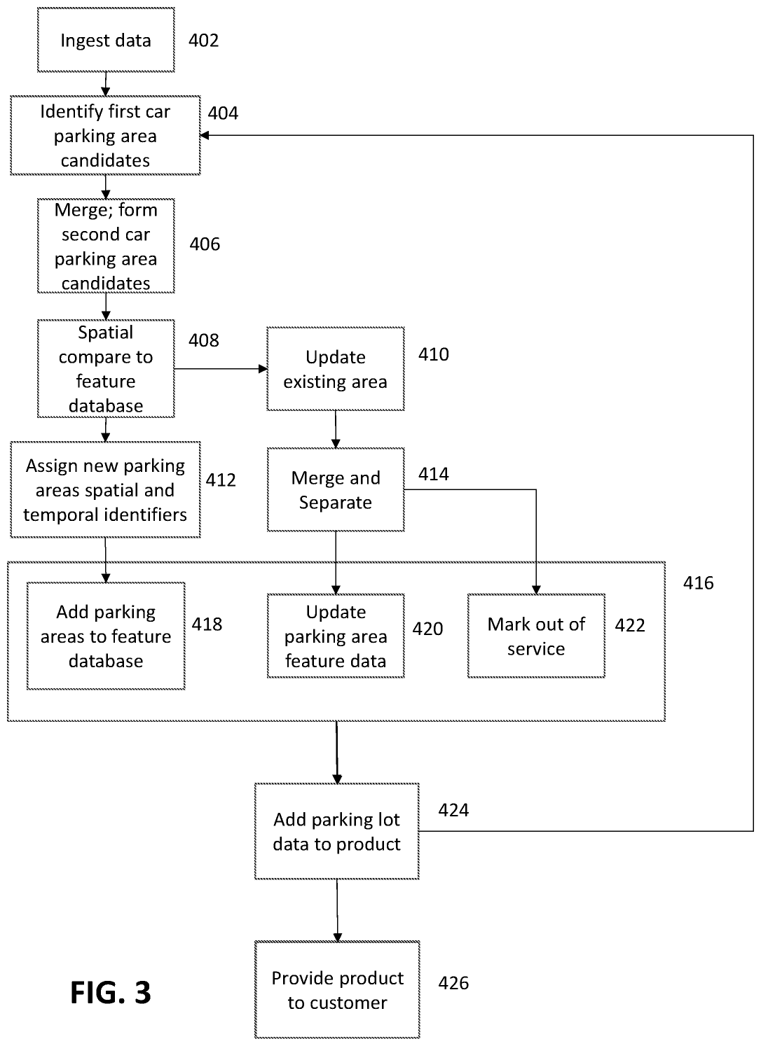

Referring now to FIG. 3, the system 10 steps and operations to update and maintain the parking areas are set forth. Block 402 refers to the ingestion and processing of connected vehicle data to create real-time and near-real time Journey information. The vehicle event data processed in the steps of FIG. 3 described below may be a time-limited set of vehicle event data, which is a set of vehicle event data for a particular period of time, which may amount to a short period of time (e.g., a few minutes) or a long period of time (e.g., days, weeks, or even years), depending on the embodiment and/or application in which the method is used. Block 404 generally represents the operations described with reference to FIG. 2 to determine the parking areas using a defined time set of journey data, for example, journeys collected during the prior week. At this point, the parking areas are considered the first candidate car parking areas, subject to further operations as described below.

Block 406 represents operations to spatially compare the first candidate parking areas, using the geohash associated with each first candidate car parking area to find potential overlap with other first candidate parking areas. When overlap is found, a spatial merging criteria is met and the overlapping areas are merged. If no overlap is found with a specific area, no change is made to that area. The results of this operation are considered the second car parking area candidates.

At block 408, using geohash data associated with each second parking area candidate and with existing parking areas in the parking area data set, the system 10 operations perform spatially comparing of the second car parking area candidates to existing car park areas. As a result of this operation, when an overlap in areas is found, the spatial merging criteria is met and overlapping second car parking area candidate and the existing car park area are merged at block 410. This merger maintains the identity of the existing car park area in the data set, and sets the boundary of the existing car park area to the greater of the existing boundary and the boundary of the overlapping second car parking area candidate. The updated car park areas are considered the update car parking area candidates. Each second car parking area candidate that does not overlap with an existing car parking are from the data set is designated as a new car parking area. At block 412, the system 10 assigns the new car parking areas identifiers with spatial and temporal components (for example, geohash information and a timestamp).

At block 414, the system operations spatially compare the update car parking area candidates. This operation merges the update car parking area candidates that meet spatial merging criteria, for example, with overlapping geographical boundaries. When two update car parking area candidates are merged, the identifier for one of the candidates is preserved and updated with the merged geoboundary information and the identifier of the other candidate area is designated as out of service.

Within block 416, block 418 represents the operation of adding the new parking areas from the operations at block 412 to the parking area data set or database. Block 420 represents the operation of updating existing parking area records in the data set or database with results of the merge operation at block 414 and with those update car parking area candidates at block 414 for which no merger is necessary. Block 422 represents updating existing parking area records in the data set or database with the out of service information determined at block 414.

The operations and steps of blocks 404 through 422 are executed periodically at a period set by the system implementer and may be daily, weekly, monthly or at any other regular, irregular, or event-triggered interval. Events triggering an update could be a certain volume threshold of journeys is reached in a given geospatial region.

Block 424 represents adding the parking area data set to a data product and block 426 represents delivering the product to a customer. The data product can be any type of data product suitable for use of the parking area data set, and may be combined with Journey data or processed Journey data. The data product may be delivered as a graphical information display to a data customer, as digital output or streaming or broadcast data, or may be a data set provided to the customer for use by the customer's own computing system.

It may be desirable, once parking areas are formed, for the system 10 to track, record and analyze vehicle event parking data for historical occupancy for that parking area. Factors that can be analyzed include, for example, time of day, day of week and so on. All of this information can then be combined with current occupancy of the parking, which allows estimating the probability of empty spaces within the parking. Accordingly, outputs can include: parking location, parking boundaries, and a probability of empty space within the boundaries at a given or current time. The analysis outputs can be outputted, for example, to third parties, downstream interfaces (e.g., for notifications as to available parking), GIS visualization tools, or stored for further processing analysis.

In an example, the system can be configured to identify curbside parking areas. Referring again to FIG. 2, at block 545 the system is configured to select points for curbside parking area analysis. Journey start points and Journey end points are selected for defining parking. Then, the algorithm the selects start points and end points that are nearby to a road. For example, the system 10 can be configured to select vehicle event data points that are 30-40 meters from the centerline of a road or road segment. The system 10 can be configured to filter out points for roads that are not likely to have parking. The system 10 can be configured to filter out points for roads that are not likely to have curbside parking. For example, motorways, interstate highways, service roads, and the like are excluded. At block 548, the system 10 is configured to cluster these points into curbside point clusters. In an embodiment, as noted above, it was found a density-based clustering algorithm, DBSCAN provided improved results for identifying curbsides via clustering journey vehicle event data points.

The boundaries of the curbside point clusters are geoshaped to geographical areas. At block 550, the system 10 is configured to define a convex hull around the cluster of curbside points. At block 552, the map-matched convex hull defines a curbside parking area.

As with other parking areas, once the curbside parking area is formed, the system 10 is configured to track, record and analyze vehicle event parking data for historical occupancy for that curbside parking area. Factors that can be analyzed include, for example, time of day, day of week and so on. All of this information can then be combined with current occupancy of the parking, which allows estimating the probability of empty spaces within the parking. Accordingly, outputs can include: parking location, parking boundaries, and a probability of empty space within the boundaries at a given or current time. The analysis outputs can be outputted via the Egress Server system 400, for example, to third parties, downstream interfaces (e.g., for notifications as to available parking), or stored in Analytics Server system 500 for further processing analysis.

In another embodiment, the system can be configured to identify parking areas based on points of interest (POIs). The system is configured to obtain map data and POI data from one or more databases. The system 10 can be configured to identify POIs that are in close proximity to the parking area shape. At block 552 (FIG. 2), the map-matched shapes define parking areas. For example, the system is configured to match POIs within a predetermined distance of the identified car park. The predetermined distance can be for example, a closest POI to a car park, a POI within 50-200 meters, or a combination thereof. For example, in an embodiment, the system can be configured match all POIs within 100 meters of the identified car park to the car park.

Once the parking area is formed, at block 554, the system 10 can be configured to track, record and analyze vehicle event parking data for features that further identify parking areas. Once shapes defining parking areas have been identified using DBSCAN and convex hull as described herein, further Journeys ending within those shapes can be analyzed, and data can be aggregated for the parking area as a whole, for example, by average dwell time, mean distance travelled to the parking area, and so on. This analysis can then be input to train a machine learning model described below. The system provides, for example, a map or parking lot database with identified parking lots that are not associated with nearby POIs. The system also provides the parking lots that are labelled to POIs to the database. This allows the system to enrich the databases with the updated POI data.

In another embodiment, the system can be configured to identify parking areas employing a map splitting enhancement to improve accuracy and processing efficiency. Starting with a large map dataset, the United States for example, the large map is split into a plurality of geohashes. Then, the system splits each of the plurality of geohashes into constituent polygons using road segments. In operation, for example, Journey or trip end points from vehicle events are selected for each constituent road segment polygon to define parking areas. By splitting the target map into a plurality of smaller geohashes, the system can then efficiently process the separate geohashes in parallel, thereby expediting the processing workload and improving system latency. For example, the processing enhancement can be implemented to identify curbside parking as described above, by clustering the points for each of the separate geohashes in parallel and completing the remaining steps 550-552 in parallel.

Any of the processing or executing instructions that is performed herein may be performed by one or more processors by executing computer instructions stored in memory, such as in one or more memory devices accessibly by the one or more processors. Thus, in some embodiments, said processing or executing instructions may be performed by a single processor and, in other embodiments may be divided among and together performed by a plurality of processors, any or all of which may be co-located or remotely located. Any one or more of the processors discussed herein are electronic processors that may be implemented as any suitable electronic hardware that is capable of processing computer instructions and may be selected based on the application in which it is to be used. Examples of types of electronic processors that may be used include central processing units (CPUs), graphics processing units (GPUs), field-programmable gate arrays (FPGAs), application specific integrated circuits (ASICs), microprocessors, microcontrollers, etc. Any one or more of the computer-readable memory discussed herein may be implemented as any suitable type of non-transitory memory that is capable of storing data or information in a non-volatile manner and in an electronic form so that the stored data or information is consumable by the electronic processor.

The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It should be appreciated that the computers or servers may include other memory, such as volatile RAM that is used by the electronic processor, and/or may include multiple processors.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A system comprising: a memory including computer instructions and at least one processor configured to execute the computer instructions to at least:
ingest vehicle event data;
process the vehicle event data at a server to identify a plurality of parking areas, wherein the processing comprises:
periodically identifying first car parking area candidates from a set of the ingested vehicle event data;
merging car parking area candidates of the first car parking area candidates that meet spatial merging criteria to determine second car parking area candidates;
spatially comparing the second car parking area candidates to existing car park areas to allocate the second car parking area candidates into update car parking area candidates and new car parking areas;
merging the update car parking area candidates that meet spatial merging criteria to allocate the update car parking area candidates into updated car parking areas and out of service car parking areas;
assigning spatial and temporal identifiers to the new car parking areas; and
updating a parking area data set responsive to the new car parking areas, the updated car parking areas, and the out of service car parking areas;
add the parking area data set to a data product; and
provide the data product to a customer.

2. The system of claim 1, wherein the processing for identifying first car parking area candidates includes clustering a plurality of journey points indicated by the ingested vehicle event data to obtain a cluster of points and defining a shape around the cluster of points.

3. The system of claim 2, wherein the processing for identifying first car parking area candidates further includes:
identifying a plurality of journeys from the ingested vehicle event data;
matching the ingested vehicle event data to map data from a map database;
selecting the plurality of journey points from the plurality of journeys; and
clustering the selected journey points with a clustering algorithm to obtain the cluster of points.

4. The system of claim 3, wherein the plurality of journey points from the plurality of journeys are selected based on whether corresponding vehicle event data indicates a journey start or journey end.

5. The system of claim 2, the shaped defined around the cluster of points is a geoshape that is represented by a geohash.

6. The system of claim 1, wherein the processing for merging car parking area candidates of the first car parking area candidates includes determining whether there is a spatial overlap between a first car parking area candidate and a second car parking area candidate and merging the first car parking area candidate and the second car parking area candidate in response to determining that there is a spatial overlap between the first car parking area candidate and the second car parking area candidate.

7. The system of claim 1, wherein the processing for spatially comparing the second car parking area candidates to existing car park areas includes determining whether a second parking area candidate spatially overlaps with an existing car park area and, wherein the processing further includes determining the second parking area candidate as an update parking area candidate when it is determined that the second parking area candidate spatially overlaps with an existing car park area and determining the second parking area candidate as a new parking area when it is determined that the second parking area candidate does not spatially overlap with an existing car park area.

8. The system of claim 1, wherein the processing for spatially comparing the second car parking area candidates to existing car park areas includes, for a second car parking area candidate, comparing a geohash indicating a geographical boundary of the second car parking area candidate to a geohash indicating a geographical boundary of an existing car park area.

9. The system of claim 1, wherein the spatial and temporal identifiers to the new car parking areas includes a geohash and a timestamp.

10. The system of claim 1, wherein a first one of the out of service car parking areas is determined as a first update car parking area candidate in response to determining that the first update car parking area candidate is to be merged with a second update car parking area candidate.

11. A method of updating a parking area data set and using the updated parking area data set for providing a data product, comprising:
ingesting vehicle event data;
periodically identifying first car parking area candidates from a set of the ingested vehicle event data;
merging car parking area candidates of the first car parking area candidates that meet spatial merging criteria to determine second car parking area candidates;
spatially comparing the second car parking area candidates to existing car park areas to allocate the second car parking area candidates into update car parking area candidates and new car parking areas;
merging the update car parking area candidates that meet spatial merging criteria to allocate the update car parking area candidates into updated car parking areas and out of service car parking areas;
assigning spatial and temporal identifiers to the new car parking areas; and
updating a parking area data set responsive to the new car parking areas, the updated car parking areas, and the out of service car parking areas; and
providing the data product to a customer, wherein the data product includes data generated based on the parking area data set.

12. The method of claim 11, wherein the identifying first car parking area candidates step includes clustering a plurality of journey points indicated by the ingested vehicle event data to obtain a cluster of points and defining a shape around the cluster of points.

13. The method of claim 12, wherein the identifying first car parking area candidates step further includes:
identifying a plurality of journeys from the ingested vehicle event data;
matching the ingested vehicle event data to map data from a map database;
selecting the plurality of journey points from the plurality of journeys; and
clustering the selected journey points with a clustering algorithm to obtain the cluster of points.

14. The method of claim 13, wherein the plurality of journey points from the plurality of journeys are selected based on whether corresponding vehicle event data indicates a journey start or journey end.

15. The method of claim 12, the shaped defined around the cluster of points is a geoshape that is represented by a geohash.

16. The method of claim 11, wherein the merging car parking area candidates of the first car parking area candidates step includes determining whether there is a spatial overlap between a first car parking area candidate and a second car parking area candidate and merging the first car parking area candidate and the second car parking area candidate in response to determining that there is a spatial overlap between the first car parking area candidate and the second car parking area candidate.

17. The method of claim 11, wherein the spatially comparing the second car parking area candidates to existing car park areas step includes determining whether a second parking area candidate spatially overlaps with an existing car park area and, wherein the method further includes determining the second parking area candidate as an update parking area candidate when it is determined that the second parking area candidate spatially overlaps with an existing car park area and determining the second parking area candidate as a new parking area when it is determined that the second parking area candidate does not spatially overlap with an existing car park area.

18. The method of claim 11, wherein the spatially comparing the second car parking area candidates to existing car park areas step includes, for a second car parking area candidate, comparing a geohash indicating a geographical boundary of the second car parking area candidate to a geohash indicating a geographical boundary of an existing car park area.

19. The method of claim 11, wherein the spatial and temporal identifiers to the new car parking areas includes a geohash and a timestamp.

20. The method of claim 11, wherein a first one of the out of service car parking areas is determined as a first update car parking area candidate in response to determining that the first update car parking area candidate is to be merged with a second update car parking area candidate.
